(19) United States
(12) Patent Application Publication
(10) Pub. No.: US 2026/0005800 A1
(43) Pub. Date: Jan. 1, 2026

(54) INCORPORATING A SOLICITING FRAME SIGNATURE INTO A MESSAGE INTEGRITY CHECK (MIC) OF A RESPONSE FRAME

(71) Applicant: Apple Inc., Cupertino, CA (US)

(72) Inventors: Jarkko L. Kneckt, Los Gatos, CA (US); Anuj Batra, Redwood City, CA (US); Qi Wang, Sunnyvale, CA (US); Yanjun Sun, San Diego, CA (US); Yong Ho Seok, Cupertino, CA (US); Yong Liu, Campbell, CA (US)

(21) Appl. No.: 19/252,776

(22) Filed: Jun. 27, 2025

Related U.S. Application Data
(60) Provisional application No. 63/665,390, filed on Jun. 28, 2024.

(51) Int. Cl. H04L 1/1607

(52) U.S. Cl. CPC H04L 1/1671; H04L 1/1614; H04L 1/1635

(57) ABSTRACT

Disclosed are methods, systems, and computer-readable medium to perform operations including: receiving a soliciting frame from a device; generating a response frame including a message integrity check (MIC), where the MIC is determined based at least in part on one or more values of the soliciting frame; and transmitting the response frame to the device.

### CROSS-REFERENCE TO RELATED APPLICATIONS

This application claims priority to and the benefit of U.S. Provisional Patent Application No. 63/665,390, filed Jun. 28, 2024, the entire contents of which is incorporated herein by reference.

### BACKGROUND

Many electronic devices communicate with each other using wireless local area networks (WLANs), such as those based on a communication protocol that is compatible with an Institute of Electrical and Electronics Engineers (IEEE) standard, e.g., the IEEE 802.11 standard (also known as “Wi-Fi”). A WLAN typically includes an access point that provides one or more stations (STAs) with access to another network, such as the Internet. There are many generations of the IEEE 802.11 standard, including 802.11ax (Wi-Fi 6) and 802.11be (Wi-Fi 7).

IEEE 802.11 is a packet-based protocol. Under this protocol, a transmitter, e.g., an access point (AP), packages control information or user data into a protocol data unit (PDU) in a physical layer convergence protocol (PLCP). The PLCP PDU (PPDU) includes a preamble and a data field, among other fields. After generating the PPDU, the access point can send the PPDU to a station connected to the access point. Communication from the access point to a station is referred to as the downlink, and the communication from a station to the access point is referred to as the uplink.

### SUMMARY

The present disclosure describes techniques for protecting the integrity of a response frame by incorporating values of a soliciting frame. In particular, one or more values of the soliciting frame, such as static field values and/or a header packet number (HDR PN) value, among others, are used in combination with values of the response frame to calculate a message integrity check (MIC) for the response frame. In this manner, the MIC not only verifies the integrity of data in the response frame, but also verifies receipt of the soliciting frame, thereby preventing replay attacks and enhancing the integrity of data transmissions. The present disclosure also provides a format for an integrity protected QoS-Null frame, as well as techniques for control signaling in a Multi-STA Block Acknowledgment (M-STA BA) and an improved control frame.

In general, in a first aspect, a method includes: receiving a soliciting frame from a device; generating a response frame including a message integrity check (MIC), where the MIC is determined based at least in part on one or more values of the soliciting frame; and transmitting the response frame to the device.

In a second aspect combinable with the first aspect, the one or more values of the soliciting frame include one or more values of one or more fields in a medium access control (MAC) header of the soliciting frame.

In a third aspect combinable with the first or second aspects, the one or more fields in the MAC header of the soliciting frame include at least one of a power management field, a more data field, an end of service period (EOSP) field, a high-throughput control field, or a reserved field.

In a fourth aspect combinable with any of the first through third aspects, the one or more fields in the MAC header of the soliciting frame include one or more static fields.

In a fifth aspect combinable with any of the first through fourth aspects, the one or more values of the soliciting frame include a header packet number (HDR PN) of the soliciting frame.

In a sixth aspect combinable with any of the first through fifth aspects, the soliciting frame includes a control frame, a trigger frame, or a block acknowledgement request (BAR) frame.

In a seventh aspect combinable with any of the first through sixth aspects, the MIC is determined based on the one or more values of the soliciting frame and one or more values of the response frame.

In an eighth aspect combinable with any of the first through seventh aspects, the response frame includes a block acknowledgement for the soliciting frame.

In a ninth aspect combinable with any of the first through eighth aspects, the one or more values of the soliciting frame include a value of a duration field of the soliciting frame.

In general, in a tenth aspect, a method includes: transmitting a soliciting frame to a device; receiving a response frame, the response frame including a first message integrity check (MIC); determining a second MIC based on one or more values of the soliciting frame and one or more values of the response frame; and comparing the first MIC and the second MIC to verify the integrity of the response frame.

In an eleventh aspect combinable with the tenth aspect, the method includes: accepting the response frame in response to determining that the first MIC matches the second MIC; or rejecting the response frame in response to determining that the first MIC does not match the second MIC.

In a twelfth aspect combinable with the tenth or eleventh aspects, the method includes: comparing the first MIC and the second MIC to verify receipt of the soliciting frame by the device.

In a thirteenth aspect combinable with any of the tenth through twelfth aspects, the one or more values of the soliciting frame include one or more values of one or more fields in a MAC header of the soliciting frame.

In a fourteenth aspect combinable with any of the tenth through thirteenth aspects, the one or more fields in the MAC header of the soliciting frame include at least one of a power management field, a more data field, an EOSP field, a high-throughput control field, or a reserved field.

In a fifteenth aspect combinable with any of the tenth through fourteenth aspects, the one or more fields in the MAC header of the soliciting frame include one or more static fields.

In a sixteenth aspect combinable with any of the tenth through fifteenth aspects, the one or more values of the soliciting frame include a HDR PN of the soliciting frame.

In a seventeenth aspect combinable with any of the tenth through sixteenth aspects, the soliciting frame includes a control frame, a trigger frame, or a BAR frame.

In an eighteenth aspect combinable with any of the tenth through seventeenth aspects, the response frame includes a block acknowledgement for the soliciting frame.

In general, in a nineteenth aspect, a method includes: generating a control frame based on a multi-station block acknowledgement (M-STA BA) frame, by: setting a value of an acknowledgement (ACK) type field and a value of a traffic identifier (TID) field in the M-STA BA frame according to a predefined combination indicating that a per association identifier (AID) TID information field contains control signaling; and inserting control signaling into the per AID TID information field; and transmitting the control frame to a receiver.

In twentieth aspect combinable with the nineteenth aspect, generating the control frame includes: setting a value of a frame control type field to control frame; and setting a value of a frame control subtype field to block ack frame.

In a twenty-first aspect combinable with the nineteenth or twentieth aspects, generating the control frame includes setting a BA type field to a value of 12.

In a twenty-second aspect combinable with any of the nineteenth through twenty-first aspects, the predefined combination indicating that the per AID TID information field contains control signaling includes setting the value of the ACK type field to 1 and the value of the TID field to 12.

In a twenty-third aspect combinable with any of the nineteenth through twenty-second aspects, inserting the control signaling into the per AID TID information field includes inserting the control signaling into a BA bitmap.

In general, in a twenty-fourth aspect, a method includes: generating a M-STA BA frame with control signaling, by: setting a value of an ACK type field and a value of a TID field in the M-STA BA frame according to a predefined combination indicating that a per AID TID information field contains control signaling; and inserting control signaling into the per AID TID information field; and transmitting the M-STA BA frame with the control signaling to a receiver.

In a twenty-fifth aspect combinable with the twenty-fourth aspect, generating the M-STA BA frame includes: setting a value of a frame control type field to control frame; and setting a value of a frame control subtype field to block ack frame.

In a twenty-sixth aspect combinable with the twenty-fourth or twenty-fifth aspects, generating the M-STA BA frame includes setting a BA type field to a value of M-STA BA.

In a twenty-seventh aspect combinable with any of the twenty-fourth through twenty-sixth aspects, the predefined combination indicating that the per AID TID information field contains control signaling includes setting the value of the ACK type field to 1 and the value of the TID field to 12.

In a twenty-eighth aspect combinable with any of the twenty-fourth through twenty-seventh aspects, inserting the control signaling into the per AID TID information field includes inserting the control signaling into a BA bitmap.

In a twenty-ninth aspect combinable with any of the twenty-fourth through twenty-eighth aspects, generating the M-STA BA frame further includes setting an AID11 field with an AID of the receiver.

In general, in a thirtieth aspect, a method includes: generating a quality of service (QOS) null frame, the QoS null frame include at least one of a HDR PN or a header message integrity check (HDR MIC); and transmitting the QoS null frame to a receiver.

In a thirty-first aspect combinable with the thirtieth aspect, the QoS null frame further includes at least one of an indication whether the QoS null frame is integrity protected, or a key used for the HDR MIC calculation.

In general, in a thirty-second aspect, an apparatus includes one or more processors configured to perform the method of any of the first through thirty-first aspects.

In general, in a thirty-third aspect, a system includes one or more processors configured to perform the method of any of the first through thirty-first aspects.

In general, in a thirty-fourth aspect, a non-transitory computer storage medium is encoded with instructions executable by one or more processors to perform the method of any of the first through thirty-first aspects.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example of a replay attack in a wireless communication network, according to some implementations.

FIG. 2 illustrates a block diagram of example of electronic devices communicating wirelessly, according to some implementations.

FIG. 3 illustrates an example of an integrity protected Aggregate MAC Protocol Data Unit (A-MPDU) and a Multi-STA Block Acknowledgment (M-STA BA), according to some implementations.

FIG. 4 illustrates an example of integrity protecting a response frame using values of static fields in the soliciting frame, according to some implementations.

FIG. 5 illustrates an example of integrity protecting a response frame using a header packet number (HDR PN) of the soliciting frame, according to some implementations.

FIG. 6 illustrates an example of integrity protecting a response frame using values of static fields and a HDR PN of the soliciting frame, according to some implementations.

FIG. 7 illustrates an example of a control response MIC calculation for high-efficiency (HE) trigger-based (TB) PPDUs, according to some implementations.

FIG. 8 illustrates examples of soliciting frame signatures that can be included in the MIC of the response frame, according to some implementations.

FIG. 9 illustrates an example of using the service field as the soliciting frame signature, according to some implementations.

FIG. 10 illustrates an example of using the duration field as the soliciting frame signature, according to some implementations.

FIG. 11 illustrates an example of using the HDR PN as the soliciting frame signature, according to some implementations.

FIG. 12 illustrates an example transmission of aggregated QoS-Nulls to signal the queue status of all traffic identifiers (TIDs), according to some implementations.

FIG. 13 illustrates an example format of an integrity protected QoS-Null frame, according to some implementations.

FIG. 14 illustrates examples of QoS-Null frame overhead for queue size signaling, according to some implementations.

FIG. 15 illustrates control signaling in a M-STA BA and a new control frame, according to some implementations.

FIG. 16 illustrates M-STA BA and new control frame ACK Type and TID configurations, according to some implementations.

FIG. 17 illustrates an example of control signaling in the new control frame and control response frame, according to some implementations.

FIG. 18 illustrates an example of a M-STA BA with additional signaling, according to some implementations.

FIGS. 19-23 illustrate flowcharts of example methods, according to some implementations.

FIG. 24 illustrates a block diagram of an example electronic device, according to some implementations.

### DETAILED DESCRIPTION

Wireless networks play a crucial role in enabling global communication between devices. However, the widespread adoption of wireless network also introduces the persistent threat of malicious attacks aimed at compromising data integrity, confidentiality, and availability. These attacks, which range from passive eavesdropping to active manipulation of data, pose significant risks to the security and reliability of wireless networks.

One particularly common form of attack in wireless networks is the replay attack. In a replay attack, an adversary intercepts and maliciously retransmits data that was captured from a legitimate communication session. By replaying intercepted data, the adversary can impersonate authorized users, gain unauthorized access to sensitive information, or disrupt the normal operation of networks, among others.

To mitigate the threat posed by replay and other attacks, many wireless networks employ integrity protection mechanisms to ensure that data is not altered or tampered with during transit. For example, in Wi-Fi networks, a header packet number (HDR PN) is used to protect against replay attacks. To do so, a transmitter increments the HDR PN value for each new frame that is sent to a receiver. The receiver maintains a record of the most recent HDR PN value(s) received from the transmitter, and only accepts a frame if its HDR PN value is greater than the previously received HDR PN value(s). In this manner, replay of previously received frames can be detected and discarded by the receiver.

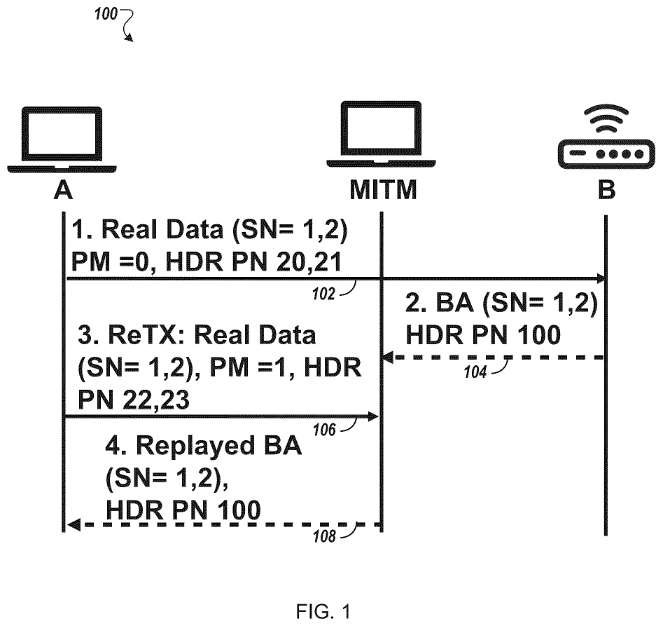

While the use of the HDR PN provides effective replay detection in many scenarios, there are vulnerabilities associated with this approach. For instance, consider the example replay attack 100 depicted in FIG. 1. Initially, device A sends frame 102 to device B. Frame 102 can be, for example, a soliciting frame or an initial control frame (ICF), such as a trigger frame or a block acknowledgment request (BAR) frame. In response, device B transmits frame 104 (e.g., an initial control response (ICR) frame) to device A. Frame 104 includes a block acknowledgment (BA) confirming receipt of frame 102, along with an HDR PN of 100. However, frame 104 is intercepted by a man-in-the-middle (MitM) attacker before reaching device A. As a result, device A cannot ascertain whether frame 102 failed to solicit a response, or if the response frame 104 failed during transmission.

Due to the uncertainty surrounding the initial transmission, device A retransmits frame 106 to device B. In this example, frame 106 mirrors the data in frame 102, but adjusts the power management (PM) bit to 1 to indicate device A's shift to a power-saving mode. However, MitM attacker intercepts frame 106 before it reaches device B. Subsequently, the attacker replays intercepted frame 104 as frame 108 to device A. Since the HDR PN value in the replayed frame 108 matches the highest HDR PN value previously received by device A from device B, device A accepts frame 108 as valid. In addition, because the content of the replayed frame 108 matches that of the frame 104, any integrity protection (e.g., message integrity check (MIC)) on the content of the frame 108 would also appear correct. This replay attack causes the physical layer (PHY) and medium access control (MAC) states between device A and device B to fall out of synchronization. For example, device B may incorrectly believe device A remains in an active mode, while device A believes device B acknowledged its transition to a power-saving mode. This desynchronization can lead to frame loss, inefficient transmission, and other vulnerabilities that can be exploited by the MitM attacker.

To improve integrity protection while addressing the foregoing vulnerabilities, the present disclosure provides techniques for incorporating values of a soliciting frame into the integrity protection of a response frame. Specifically, one or more values of the soliciting frame, such as static field values and/or the HDR PN value, are used in combination with values of the response frame to calculate a MIC for the response frame. In this manner, the MIC not only verifies the integrity of data in the response frame, but also verifies receipt of the soliciting frame. By tying receipt of the soliciting frame to the integrity protection of the response frame, the techniques described here prevent replay attacks and enhance the integrity of data transmissions. The present disclosure also provides a format for an integrity protected QoS-Null frame, as well as techniques for control signaling in a Multi-STA Block Acknowledgment (M-STA BA) and an improved control frame.

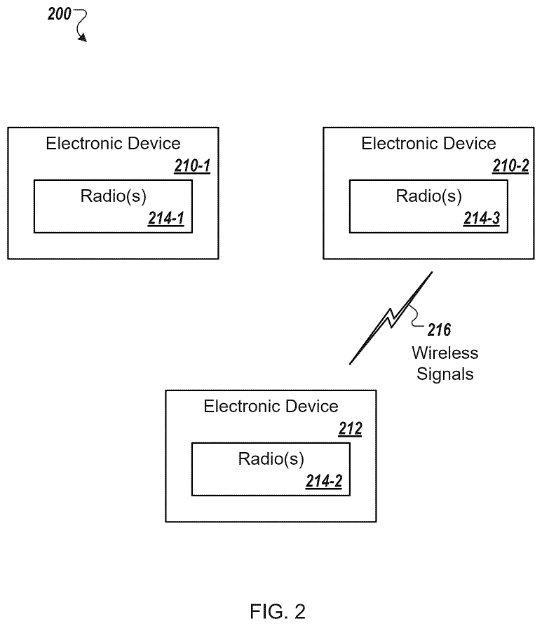

FIG. 2 illustrates a block diagram 200 of example of electronic devices communicating wirelessly, according to some implementations. Notably, one or more electronic devices 210 (such as a smartphone, a laptop computer, a notebook computer, a tablet, or another such electronic device) and access point 212 can communicate wirelessly in a WLAN using an IEEE 802.11 communication protocol. Thus, electronic devices 210 can be associated with or can have a connection with access point 212. For example, electronic devices 210 and access point 212 can wirelessly communicate while: detecting one another by scanning wireless channels, transmitting and receiving beacons or beacon frames on wireless channels, establishing connections (e.g., by transmitting connect requests), and/or transmitting and receiving packets or frames (which can include the request and/or additional information, such as data, as payloads). Note that the access point 212 can provide access to a network, such as the Internet, via an Ethernet protocol, and can be a physical access point or a virtual or “software” access point that is implemented on a computer or an electronic device. In this specification, electronic devices 210 are sometimes referred to as “recipient electronic devices” or “receiver stations.”

Although the environment shown in FIG. 2 is provided as an example, in alternative implementations, different numbers and/or types of electronic devices can be present. For example, some implementations can include more or fewer electronic devices. As another example, in some implementations, different electronic devices can be transmitting and/or receiving packets or frames. In some implementations, multiple links can be used during communication between electronic devices 210.

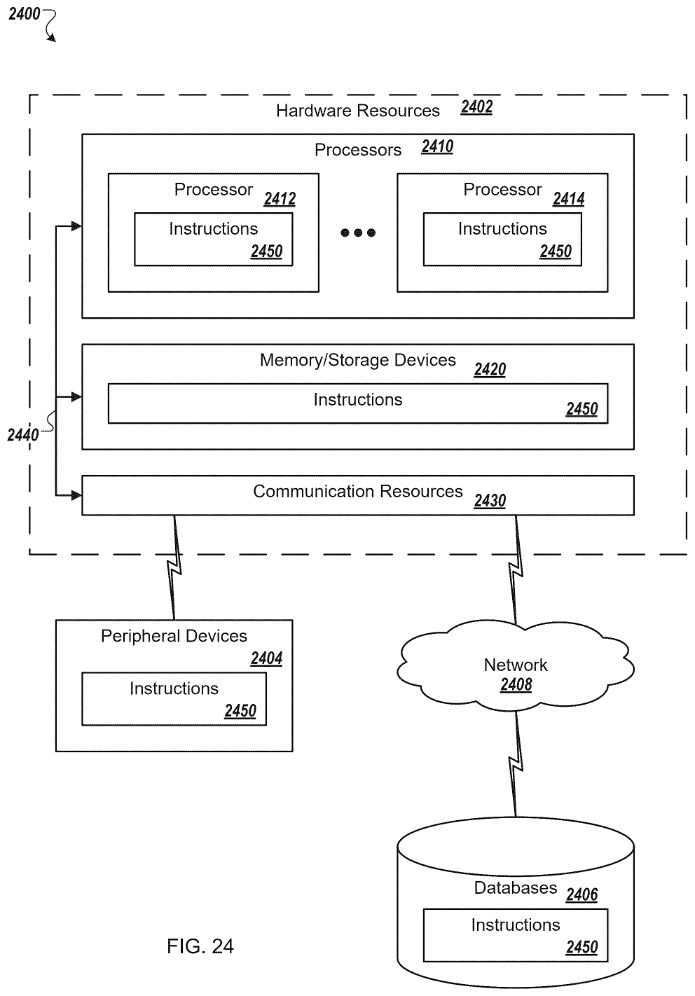

As described further below with reference to FIG. 24, electronic devices 210 and access point 212 can include subsystems, such as a networking subsystem, a memory subsystem, and a processor subsystem. In addition, electronic devices 210 and access point 212 can include radios 214 in the networking subsystems. More generally, electronic devices 210 and access point 212 can include (or can be included within) any electronic devices with networking subsystems that enable electronic devices 210 and access point 212, respectively, to wirelessly communicate with another electronic device. This can include transmitting beacons on wireless channels to enable the electronic devices to make initial contact with or to detect each other, followed by exchanging subsequent data/management frames (such as connect requests) to establish a connection, configure security options, transmit and receive packets or frames via the connection, etc.

As shown in FIG. 2, wireless signals 216 are communicated by one or more radios 214-1 and 214-2 in electronic device 210-1 and access point 212, respectively. For example, as noted previously, electronic device 210-1 and access point 212 can exchange packets or frames using a Wi-Fi communication protocol in a WLAN. Further, one or more radios 214-1 can receive wireless signals 216 that are transmitted by one or more radios 214-2 via one or more links between electronic device 210-1 and access point 212. Alternatively, the one or more radios 214-1 can transmit wireless signals 216 that are received by the one or more radios 214-2.

In some implementations, wireless signals 216 are communicated by one or more radios 214 in electronic devices 210 and access point 212, respectively. For example, one or more radios 214-1 and 214-3 can receive wireless signals 216 that are transmitted by one or more radios 214-2 via one or more links between the electronic devices 210-1 and 210-2, and the access point 212.

In some implementations, the access point 212 can group the electronic devices 210 into a target station set. The target station set concept comes from downlink multi-user transmission where the access point 212 can transmit to multiple stations simultaneously in one PPDU using Orthogonal Frequency Division Multiple Access (OFDMA) or multiuser (MU) Multiple Input Multiple Output (MU-MIMO). Here, the target station set is a set of stations that can simultaneously be served by the access point 212. The stations in the set do not need to share the same PHY parameters, such as MCS, number of streams, etc.

In some implementations, the access point 212 can simultaneously communicate with a plurality of electronic devices 210 using multiuser (MU) techniques, such as MU Multiple Input Multiple Output (MU-MIMO). In some examples, the access point 212 communicates with the electronic devices 210 using frequency multiplexing such that the access point 212 allocates each of the electronic devices a portion of the overall bandwidth. For example, to simultaneously communicate with four electronic devices over an 80 Megahertz (MHz) bandwidth, the access point 212 transmits a MU-PPDU over the 80 MHz bandwidth. The MU-PPDU includes a sub-PPDU for each of the four electronic devices, where each sub-PPDU (or sub-channel) is allocated 20 MHz. The access point 212 can use the MU-PPDU to communicate with devices in the same target set, devices in different target sets, or a combination of both.

In some implementations, access point 212 and one or more electronic devices can be compatible with an IEEE 802.11 standard that includes trigger-based channel access, e.g., IEEE 802.11ax. In 802.11ax, Orthogonal Frequency Division Multiple Access (OFDMA) is used to enable simultaneous communications between the access point 212 and multiple electronic devices. OFDMA divides the available physical spectrum into multiple orthogonal sub-channels, or resource units (RUs), which can be allocated to different electronic devices (users). Under the standard, the access point 212 coordinates multiuser OFDMA by broadcasting a trigger frame which, among other things, allocates a RU to each participating electronic device. Each electronic device responds to the trigger frame by transmitting a PPDU to the access point 212 using the allocated RU. The trigger frame can also include power control information. The access point 212 can instruct all electronic devices 210 when to start and stop transmitting. Note that access point 212 and the electronic devices 210 can communicate with one or more legacy electronic devices that are not compatible with the IEEE 802.11 standard (i.e., that do not use multi-user trigger-based channel access).

In some implementations, processing a packet or frame in one of electronic devices 210 access point 212, or a combination of both, includes: receiving wireless signals 216 encoding a packet or a frame; decoding/extracting the packet or frame from received wireless signals 216 to acquire the packet or frame; and processing the packet or frame to determine information contained in the packet or frame (such as data in the payload).

As discussed previously, one or more of electronic devices 210 and access point 212 can communicate with each other. Notably, access point 212 can transmit a PPDU that includes a preamble and a data field. In some implementations, access point 212 can be configured to use concatenated PPDUs (C-PPDUs), e.g., for low latency communications with receiver stations. A C-PPDU includes a plurality of component PPDUs, each of which includes preamble and a data payload. As described in more detail below, the C-PPDU includes a plurality of component PPDUs. The first component PPDU is preceded by a first preamble called a “full preamble.” The remaining component PPDUs in the C-PPDU are each preceded by respective preambles that are shorter in length than the first preamble. In some implementations, the access point 212 might not perform contention or receive a block acknowledgement (BA) before the plurality of component PPDUs are transmitted.

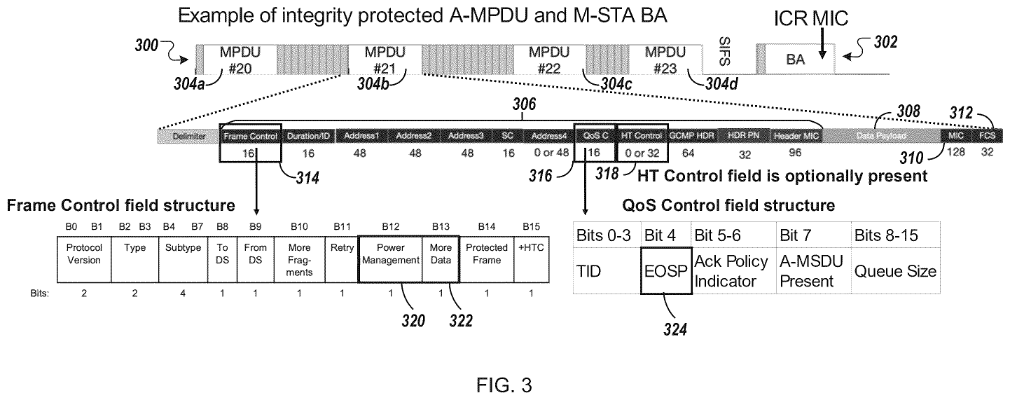

Referring to FIG. 3, an example of an integrity protected Aggregate MAC Protocol Data Unit (A-MPDU) 300 and a Multi-STA Block Acknowledgment (M-STA BA) 302 are shown. In general, the A-MPDU 300 includes multiple MAC Protocol Data Units (MPDUs) 304a-304d that are aggregated into a single larger frame before transmission. By aggregating several MPDUs 304a-304d into one A-MPDU 300, header and acknowledgment overhead can be reduced, thereby increasing the overall data throughput efficiency. The M-STA BA 302 is an extension of the Block Acknowledgment (BA) mechanism and allows an AP to send a single BA frame to multiple STAs simultaneously, thereby reducing consumption of network resources relative to sending separate ACK frames for each STA. The BA 302 can also include a MIC to provide integrity protection, as described herein.

As illustrated in FIG. 3, each of the MPDUs 304a-304d in the A-MPDU includes its own MAC header 306, data payload 308, MIC 310, and frame check sequence (FCS) 312. The MAC header 306 includes fields such as a frame control field 314, a quality of service (QOS) control field 316, and, optionally, a high-throughput (HT) control field 318, among other fields (e.g., duration/ID, addresses (source and destination), sequence control (SC), Galois/Counter Mode Protocol (GCMP) header, HDR PN, and header MIC). The frame control field 314 includes several subfields that specify information used to manage and control the transmission and reception of frames. In particular, the frame control field 314 includes a power management (PM) subfield 320 that specifies whether the transmitting STA is in an active mode (e.g., PM=0) or a power-saving mode (e.g., PM=1), as well as a more data (MD) subfield 322 that specifies whether additional data frames are buffered at the AP for the receiving STA. The QoS control field 316 is used to specify information for implementing different levels of QoS for various types of traffic (e.g., voice, video, data). For example, the QoS control field 316 includes an end of service period (EOSP) subfield 324 that indicates the end of a QoS service period for a given frame. Lastly, the HT control field 318 includes information specific to the HT capabilities and configurations.

In general, each of the MAC headers 306 of the data and management frames of a PPDU have the same values for certain fields. For instance, in some examples, each of the MAC headers 306 may have the same values for the PM subfield 320, the MD subfield 322, the EOSP subfield 324, and the HT control field 318, among others (e.g., reserved fields). The fields of the MAC headers 306 that have the same values across data and management frames of the PPDU are referred to herein as “static fields.”

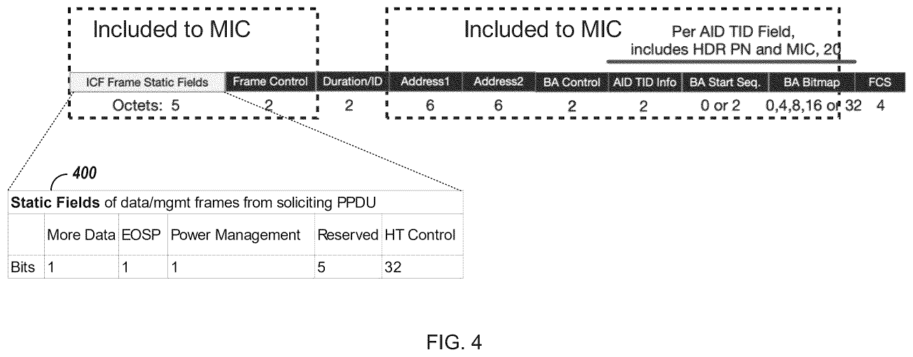

In accordance with an aspect of the present disclosure, one or more values of the static fields in a soliciting frame are used in calculation of the MIC for the response frame. In this manner, receipt of the soliciting frame is effectively linked to the integrity protection of the response frame, thereby preventing replay attacks. Referring to FIG. 4, an example of integrity protecting the response frame based in part on values of static fields in the soliciting frame is shown. In this example, static fields 400 in the soliciting frame (e.g., soliciting PPDU) include a 1-bit more data field, a 1-bit EOSP field, a 1-bit power management field, a 5-bit reserved field, and a 32-bit HT control field, although alternative or additional static fields can be used in some examples without departing from the scope of the present disclosure. The values of some or all of the static fields 400 are used in combination with values of fields in the response frame (e.g., the M-STA BA), such as the values of the frame control field, the address field(s), the BA control field, the AID TID info field, the BA start sequence field, and the BA bitmap field, to calculate the MIC for the response frame.

In general, the MIC can be calculated by applying, for example, a cryptographic hash function to the values of the static fields 400 and the fields of the response frame. Once calculated, the MIC is appended to the response frame. Upon receipt of the response frame, the receiver can recalculate the MIC using the same cryptographic hash function, and verifies the recalculated MIC against the MIC included in the response frame. If the recalculated MIC matches the MIC included in the response frame, the receiver concludes that the response frame has not been altered during transmission, and that the static fields of the soliciting frame (and, thus, the soliciting frame itself) has been received. If the MICs do not match, it indicates that the response frame may have been tampered with or corrupted in transit, or that the static fields of the soliciting frame have not been received by the intended receiver. In such cases, the receiver may discard the frame or take further action based on security policies.

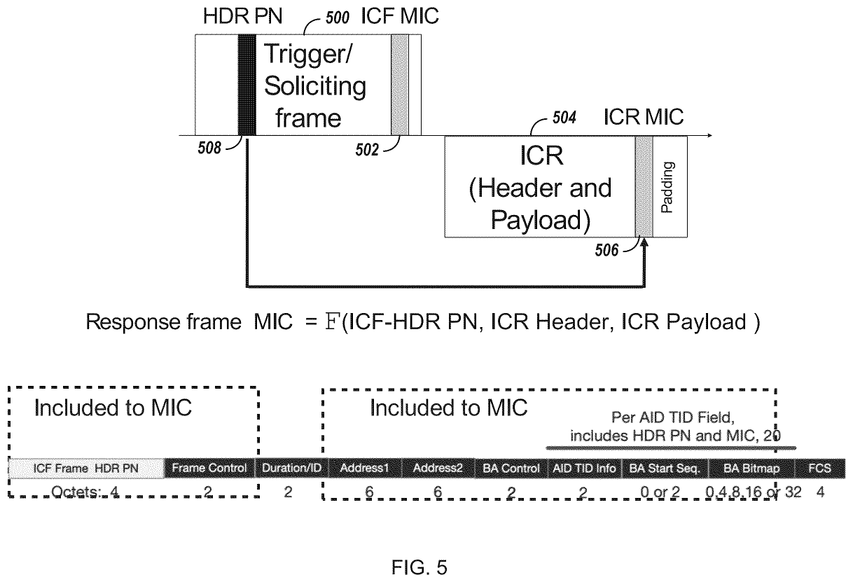

Referring to FIG. 5, an example of integrity protecting the response frame based in part on the HDR PN of the soliciting frame is shown. In this example, a trigger or BAR frame 500 is transmitted as an initial control frame (ICF). In general, the ICF may include information about link adaptation, the utilization of transmission resources (e.g., bandwidth, number of spatial streams (NSS), and transmit power), coexistence times and the availability of STAs. Potential future amendments to the Wi-Fi standards may also introduce additional types of information to the ICF.

An ICF MIC 502 ensures that the information included in the ICF is not altered or tampered with during transmission. In accordance with an aspect of the present disclosure, reception of the ICF is also verified by inclusion of one or more values of the ICF in the MIC 506 of the initial control response (ICR) frame 504. In some examples, the entire ICF can be integrated into the MIC 506 of the ICR 504. However, integrating the entire ICF may be complicated due to the ICF's variable size, and larger input sizes may necessitate additional time for MIC calculation. Accordingly, in some examples, using a fixed-size ICF “signature” can expedite MIC calculation and simplify hardware implementation. In particular, it is proposed to use the HDR PN 508 of the ICF in the calculation of the ICR MIC 506. In this example, the response frame MIC is determined as a function of the ICF-HDR PN, the ICR Header, and the ICR Payload. This approach mitigates replay attacks because the HDR PN of the subsequent ICF would not match the replayed ICR.

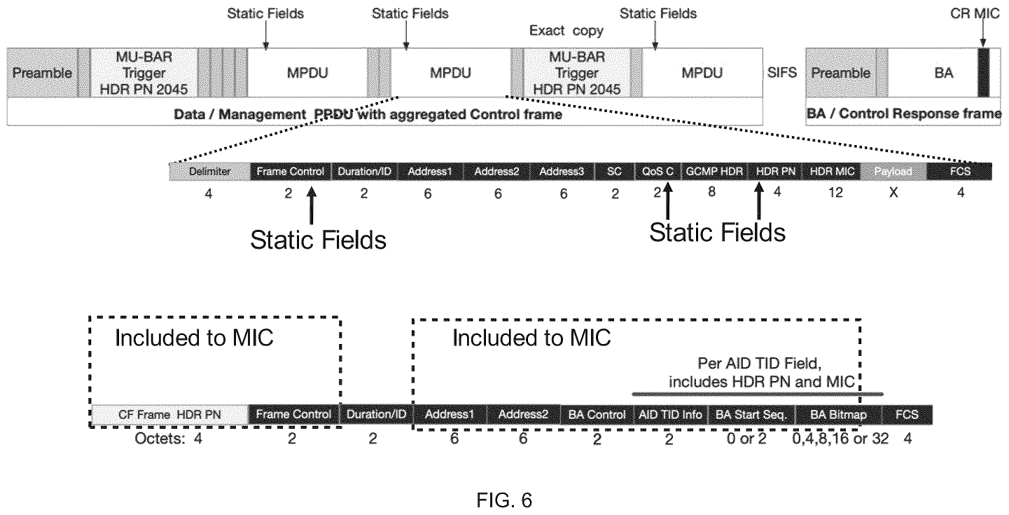

Referring to FIG. 6, an example of integrity protecting the response frame based in part on values of static fields and the HDR PN of the soliciting frame is shown. In general, a PPDU can encompass various types of frames including data frames, management frames, and trigger frames. Wi-Fi 6 defines a trigger frame as the initial frame within an A-MPDU, and further states that an A-MPDU may consist of multiple copies of this trigger frame. As such, all aggregated control frames should share the same HDR PN value and identical field values. Thus, in accordance with an aspect of the present disclosure, a control response (CR) MIC can encompass the HDR PN of the trigger or control frame. This measure prevents BA frames from being replayed maliciously. The Aggregated Control Frame reception can be signaled within the BA frame, simplifying the content of the CR MIC. In cases where the BA indicates that the Aggregated Control Frame was not received, the MIC can also include the static fields, as discussed herein.

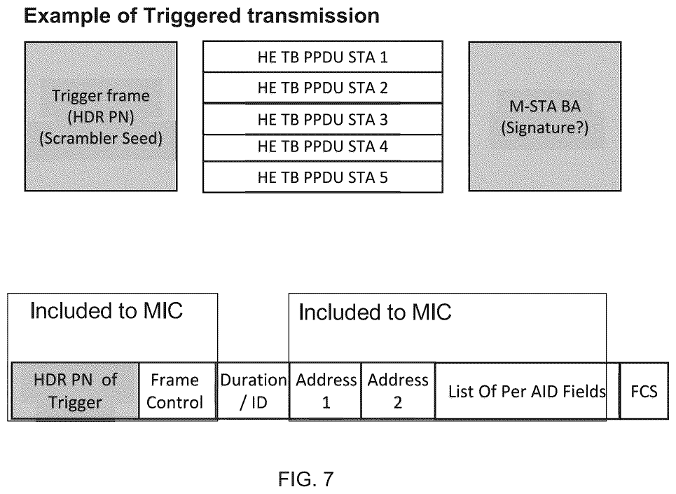

FIG. 7 illustrates an example of control response MIC calculation for high-efficiency (HE) trigger-based (TB) PPDUs, in accordance with an aspect of the present disclosure. In general, verifying reception of a HE TB PPDU through a control response MIC poses unique challenges. This is because a HE TB PPDU may include transmissions by multiple STAs, and each STA may use different values for the static fields in the transmission. In addition, the TB PPDU may be acknowledged by a single M-STA BA that is protected by a basic service set (BSS) specific MIC, and all STAs should be able to verify the BA MIC.

In accordance with an aspect of the present disclosure, the HDR PN of the trigger frame is included in the MIC of the BA/ICR. In some examples, if the AP acknowledges HE TB PPDUs separately by sending STA specific unicast BAs in a DL MU PPDU, then the static fields and HDR PN of the ICF transmitted by the STA in the HE TB are input for the MIC of the BA/ICR, and the MIC is calculated with individual keys of the STA.

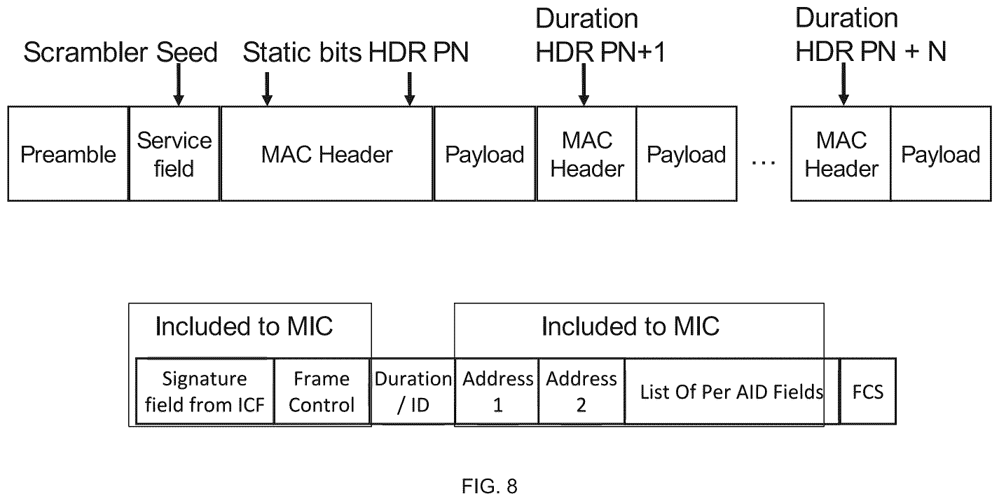

FIG. 8 illustrates examples of various ICF signatures that can be included in the CR MIC calculation, in accordance with an aspect of the present disclosure. In this example, four ICF signatures are considered: static MAC headers and ICF HDR PN, service field (e.g., scrambler seed), duration field, and HDR PN. Regarding static MAC headers and ICF HDR PN, this signature eliminates possible attacks that may be done in ICF/data/management frames. One challenge with this approach is that the Wi-Fi specifications shall require that only a single ICF frame is transmitted (e.g., HDR PN of multiple ICF may not be added). The service field (specifically, the scrambler seed) is a strong candidate for the signature, as a PPDU has a single scrambler seed, which simplifies ICR implementation, and the PPDU is received only if the scrambler seed is received. However, the scrambler seed is currently set to a random value, and there are no rules to ensure that the scrambler seed changes in consecutive frames. Ideally, scrambler seed selection should not be random—it should according to an order to avoid the same selection for consecutive frames. The duration field can also serve as the ICF signature, as each frame has a duration field, and all duration fields in a PPDU are set to the same value. However, the duration field signals NAV, the remaining TXOP duration, and there are also no rules to transmit unique duration field values. Ideally the duration field should have a unique duration in consecutive ICF frames when ICR is not correctly received. Lastly, the HDR PN can be used as the ICF signature, as each frame has a HDR PN value, and the HDR PN increases by one for each transmitted frame. However, if the ICF is an A-MPDU, it is not clear which MPDU(s) are received. If the received ICF has multiple HDR PN values, the receiver should have a rule dictating which HDR PN is added to the ICR frame (e.g., the smallest or largest HDR PN value).

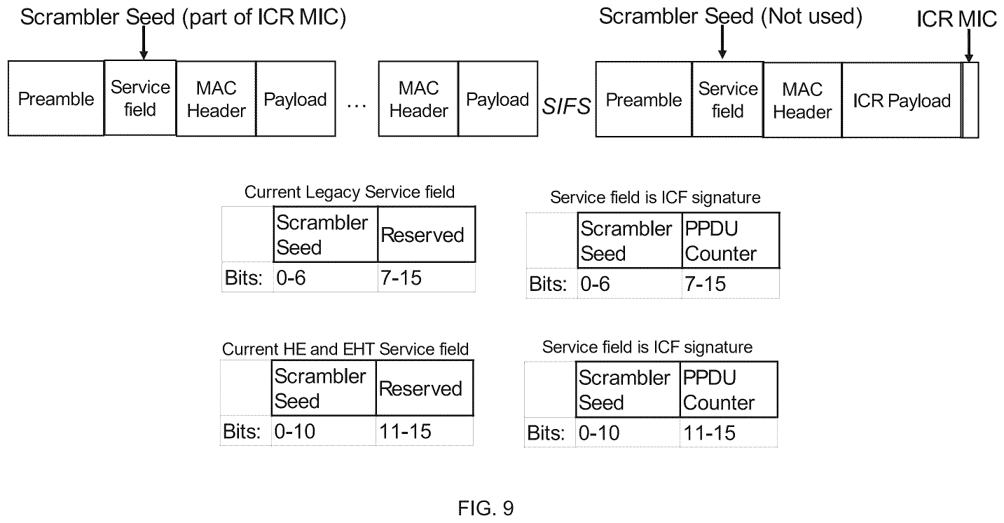

Referring to FIG. 9, an example of using the service field as the ICF signature is shown. In general, the scrambler seed is part of the 2 octets service field. As noted above, the Wi-Fi standard currently requires that the scrambler seed be set to a random value, but the value does not need to change per PPDU. Thus, to make the service field suitable as ICF signature, it is proposed to make the following enhancements:

The scrambler seed value is increased by transmitted ICF. Not all values need to be used.

Reserved bits in the service field are used as a PPDU counter, as shown at 900a (for legacy service fields) and 900b (for HE and EHT service fields). Each transmitted PPDU increases the value by 1.

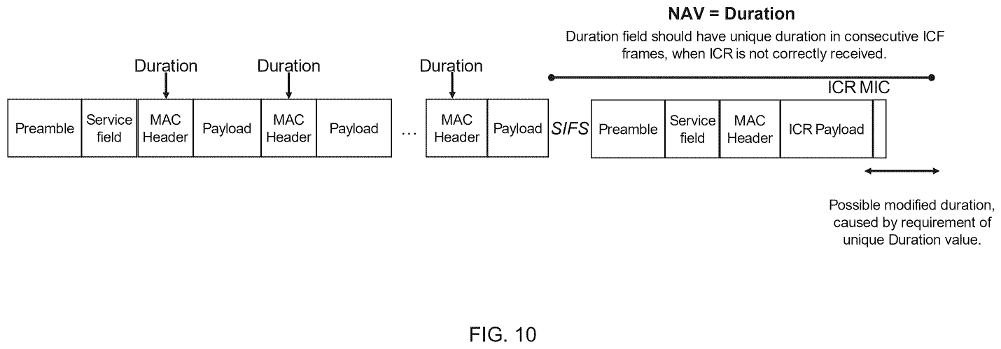

Referring to FIG. 10, an example of using the duration field as the ICF signature is shown. As noted above, the Wi-Fi standard currently does not require unique duration field values. Thus, to make the service field suitable as ICF signature, it is proposed that the transmitter stores the X most recent duration field values it has transmitted, where X is a number (e.g., 100) that balances uniqueness and storage requirements. The transmitter shall not reuse the same duration value to ensure uniqueness of the signature. It is noted that the duration field currently specifies the NAV duration in units of microseconds. Thus, if the ICR frames have very similar durations, the STA may add overhead to ensure unique duration field values.

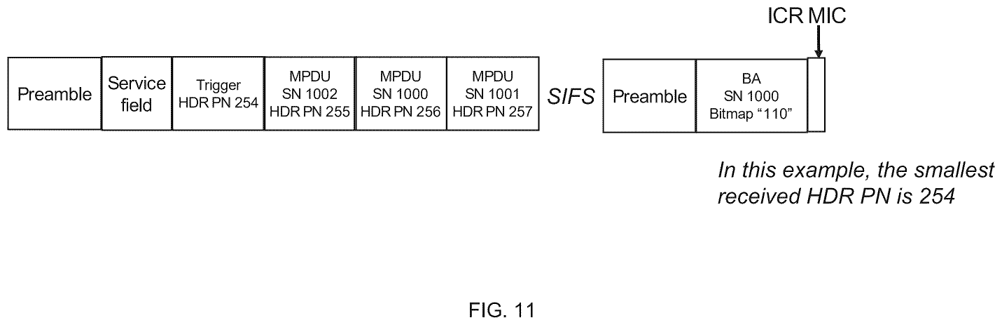

Referring to FIG. 11, an example of using the HDR PN as the ICF signature is shown. In general, using the HDR PN as the ICF signature poses some challenges, as an A-MPDU may contain multiple MPDUs each having a different HDR PN value. In this case, the transmitter does not know whether a particular MPDU is received; only the BA will signal which MPDUs were received. Thus, it is proposed to select a single HDR PN value to be used as ICF signature. In some examples, the smallest HDR PN value of the received MPDUs is selected for the ICF signature, as this provides the most time to prepare the BA. If a DL MU PPDU contains a trigger frame, then the trigger frame has the smallest HDR PN value. To determine the smallest received HDR PN value from the received BA frame, the BA window can signal the received MPDUs based on their SN values. The transmitter can then use a known mapping between HDR PNs and MPDU SN values to determine the smallest the HDR PN value from the received SN values.

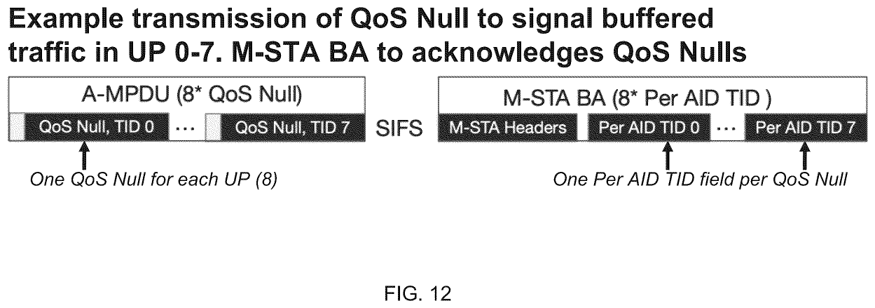

Referring to FIG. 12, an example transmission of aggregated QoS-Nulls to signal the queue status of all traffic identifiers (TIDs) is shown. In general, QoS Null frames are used to indicate the status of queues for one or all TIDs. Within the QoS Control field, bits 8 to 15 specify the amount of buffered data, representing the queue size for each TID. When multiple QoS Null frames are included in an A-MPDU, it introduces additional overhead. This is especially true when each QoS Null frame is integrity protected, as described herein. The presence of QOS Null frames is confirmed in a BA frame by incorporating a per-association identifier (Per-AID) TID field for each QoS Null frame. Availability of the QoS Null specific Per AID field is a signature of frame that solicits BA, but this may not fully identify the soliciting frame. In addition, there exists a potential vulnerability to BA replay attacks if a retransmitted data frame contains a QoS Null of the TID acknowledged in the BA.

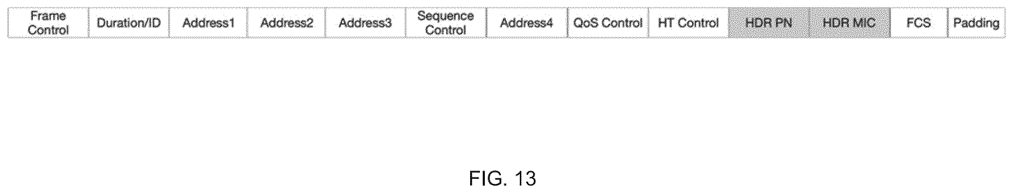

To ensure that the QoS-Null frame is not altered or otherwise tampered with during transmission, it is proposed to integrity protect the QoS-Null frame. FIG. 13 illustrates an example format of an integrity protected QoS-Null frame, in accordance with an aspect of the present disclosure. In general, QoS-Null has the same MAC header structure as QoS data frames, except that there is no GCMP header and no data payload. In some examples, the QoS-Null should contain a key ID, an indication of encrypted frame, a HDR PN, and a HDR MIC. The early indication can one bit in length, in which a value of 1 indicates that the QoS-Null frame is integrity protected and contains HDR PN and HDR MIC fields. The QoS Null frame is never retransmitted, so the retry bit may be used for this purpose. The key ID is also one bit in length and signals the key used for the HDR MIC calculation. The protected frame subfield in the frame control field may be used to contain key ID of the integrity protected QoS-Null frame. The HDR PN field can be 4 octets and can signal a unique HDR PN for each MPDU. In some examples, the HDR PN is used in the MIC calculation. The HDR MIC field can be 12 octets and can contain the MIC of the MAC header.

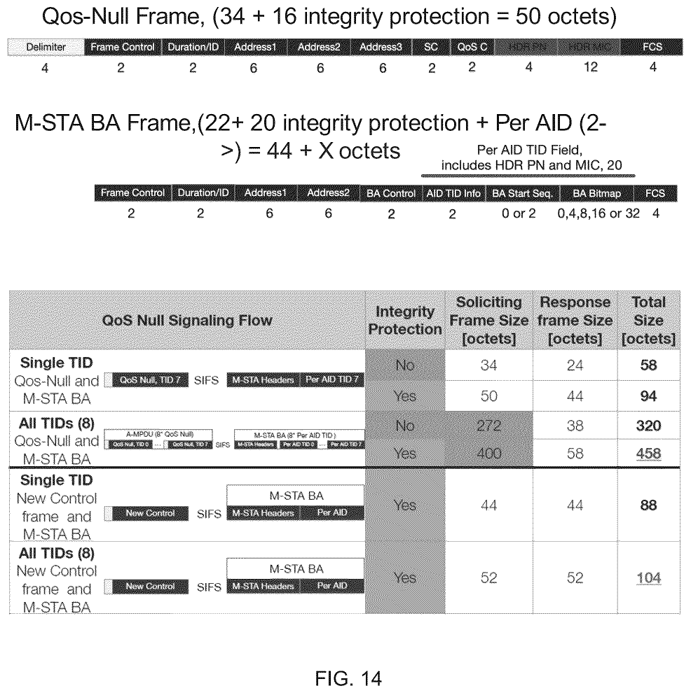

Referring to FIG. 14, examples of QoS-Null frame overhead for queue size signaling are shown. When signaling the queue size for a single TID, the size of the QoS-Null soliciting frame is 34 octets without integrity protection, and 50 octets with integrity protection (e.g., using the format shown in FIG. 13). If the queue size for all 8 TIDs is signaled, the size of the QoS-Null soliciting frame jumps to 272 octets without integrity protection, and 400 octets with integrity protection.

To reduce the overhead of multiple aggregated QoS Null frames, it is proposed to use a new control frame described herein to carry the queue size signaling. As shown in FIG. 14, this new control frame can significantly reduce the size of queue size signaling in all cases. The proposed new control frame also resolves the BA reply issues, as the HDR PN of the control frame is added to the BA MIC. Such a new control frame may aggregate all PHY and MAC state signaling, including: one or more HT control frames, transmitter availability information, BAR information, and link adaptation and coexistence information. The new control frame may be repeated multiple times to ensure its delivery.

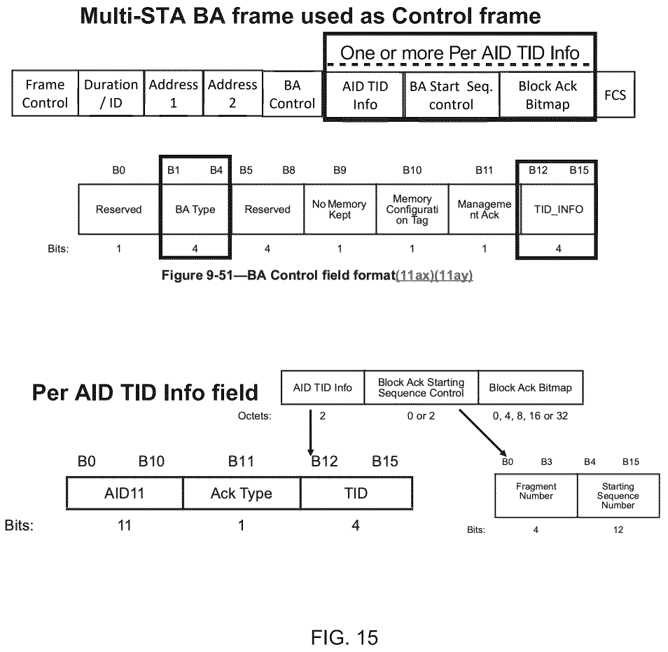

FIG. 15 illustrates control signaling in a M-STA BA and a new control frame, in accordance with an aspect of the present disclosure. In this example, M-STA BA may be used as a new control frame. To do so, Frame Control Type is set to Control frame, Frame Control SubType is set to Block Ack frame, TID_INFO bit 12 is set to 1 to signal that BA is integrity protected, and TID_INFO bit 13 signals the Key ID of the BA. In the BA Control field, BA Type is set to the value of M-STA BA (both BA and optional control signaling are included). M-STA BA can be used when the frame carries BA. In some examples, BA Type is set to value 12 of the new control frame (control signaling is included). Value 12 can be used if the PPDU does not carry BA.

The AID TID Info field AID11 field is set to the AID of the receiver. This allows M-STA BA signaling in broadcast DL frame, which may have multiple receivers. The STA's AID11 indicates that Per AID field is targeted for the STA. TBD1 AID11 value signals that Per AID field contains the HDR PN and HDR MIC fields. TBD2 AID11 value signals padding. AID11 Value 0 and 2047 signal broadcast content for all receivers.

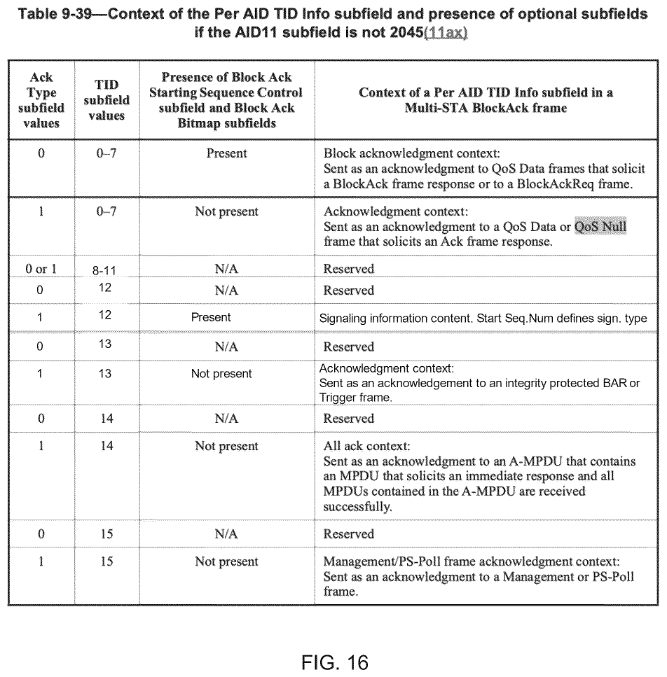

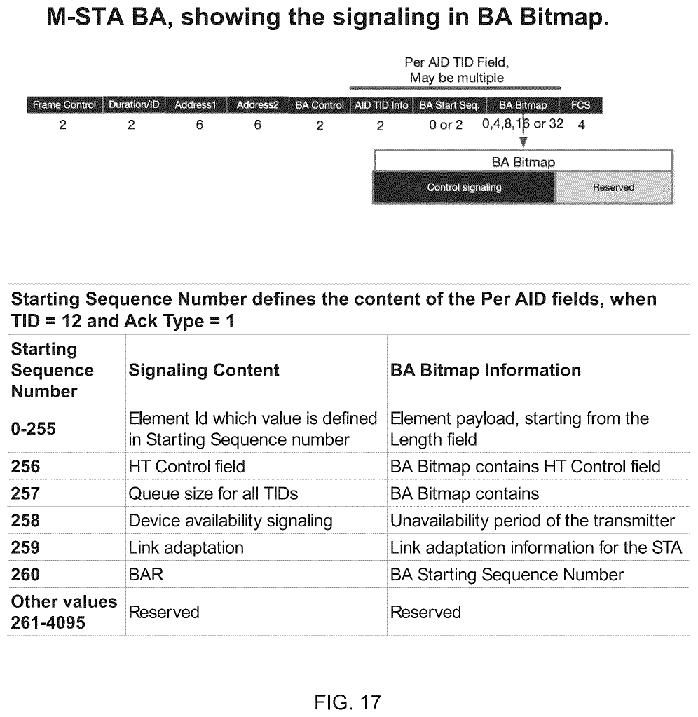

The ACK Type and TID fields define content and presence of Per AID Info, as detailed in FIG. 16. In particular, two new Ack Type and TID configurations are proposed. First, a TID field value of 12 and ACK Type value of 1 signals that the Per-AID TID field contains only control signaling. In this case, the frame may be used to signal the transmitter information. In some examples, a TID field value of 12 and an ACK Type value of 0 can be used for signaling that control signaling is not present in the BA bitmap. In some examples, other values can be used to indicate the presence of control signaling, such as an ACK Type value of 0 (and TID value of 12) for signaling that control signaling is present in the BA bitmap, and an ACK Type value of 1 (and TID value of 12) for signaling that control signaling is not present in the BA bitmap. Additional details on this configuration are described with respect to FIG. 17. Second, a TID field value of 13 and ACK Type value of 1 in M-STA BA frame is acknowledgement to a received control frame. When the BA has this value, then the HDR PN of the control frame is included to the MIC of the BA frame. Otherwise, the static fields of the data and management frames are included in the CR MIC.

Referring to FIG. 17, an example of control signaling in the new control frame and control response frame is shown. As noted above, a TID field value of 12 and Ack Type value of 1 (or 0) signals that the BA bitmap contains control or management signaling. When these values are transmitted, the Starting Sequence Number field defines the control signaling type of the Per AID TID field, and the BA Bitmap field contains the control signaling content, as illustrated in the table. In some examples, the signaling is started from the beginning of the BA Bitmap. If the signaling does not consume all of the BA Bitmap bits, the remainder of the bits can be reserved.

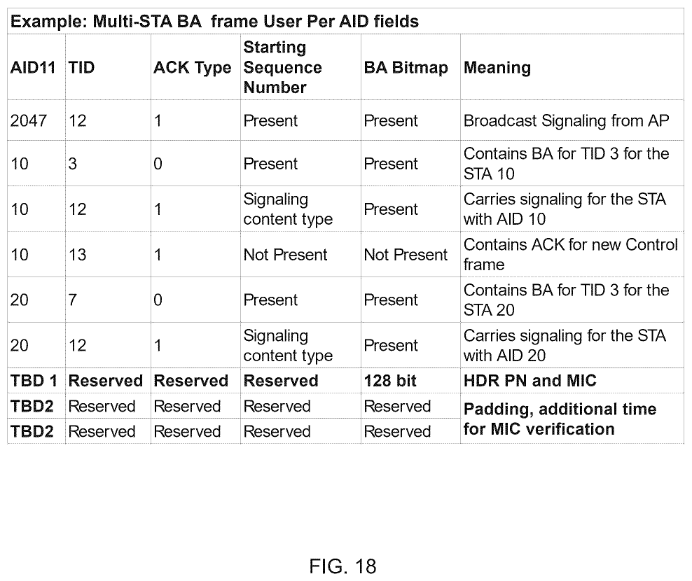

Referring to FIG. 18, an example of a M-STA BA with additional signaling is shown. In this example, AID 2047 signals broadcast information for associated STAs. A TID value of 12 and ACK Type value of 1 signals that BA Bitmap contains control signaling. AID 10 and AID 20 are allocated for 802.11bn (e.g., Wi-Fi 8) STAs. If the BA bitmap content is transmitted to the STA with the AID value: ACK Type 0 and TID 0-7 indicates block ack bitmap to unicast UL transmissions, and ACK Type 1 and TID 13 means acknowledgement to a new Control Frame transmitted by the STA with AID 10. In some examples, padding may be assigned to allocate more time for integrity verification.

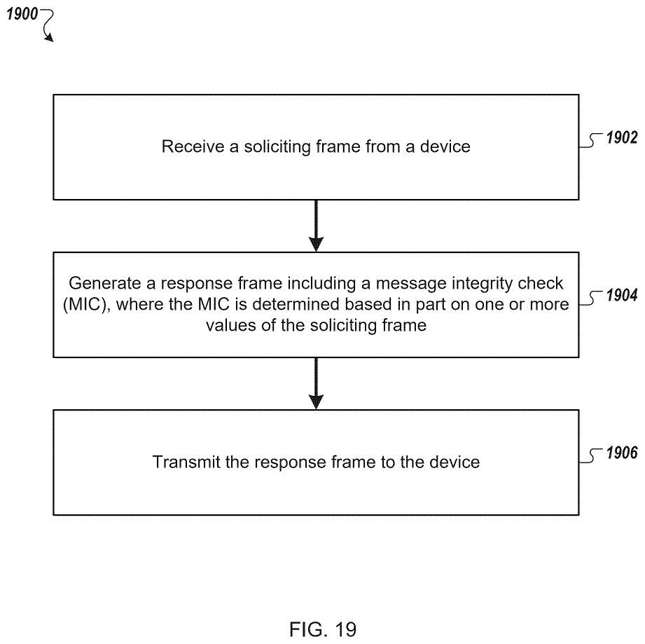

FIG. 19 illustrates a flowchart of an example method 1900, according to some implementations. For clarity of presentation, the description that follows generally describes method 1900 in the context of the other figures in this description. For example, method 1900 can be performed by access point 212 of FIG. 2. It will be understood that method 1900 can be performed, for example, by any suitable system, environment, software, hardware, or a combination of systems, environments, software, and hardware, as appropriate. In some implementations, various steps of method 1900 can be run in parallel, in combination, in loops, or in any order.

Operations of the method 1900 include receiving a soliciting frame from a device (1902). The soliciting frame can include, for example, a control frame, a trigger frame, or a block acknowledgement request (BAR) frame, among others. A response frame including a message integrity check (MIC) is generated (1904). The MIC can be determined based in part on one or more values of the soliciting frame, such as one or more values of one or more fields in a medium access control (MAC) header of the soliciting frame, including the HDR PN and/or one or more static fields of the MAC header (e.g., a power management field, a more data field, an end of service period (EOSP) field, a high-throughput control field, and/or a reserved field). In some examples, the MIC is determined based on the one or more values of the soliciting frame and one or more values of the response frame. The response frame is then transmitted to the device (1906). In some examples, the response frame includes a BA for the soliciting frame.

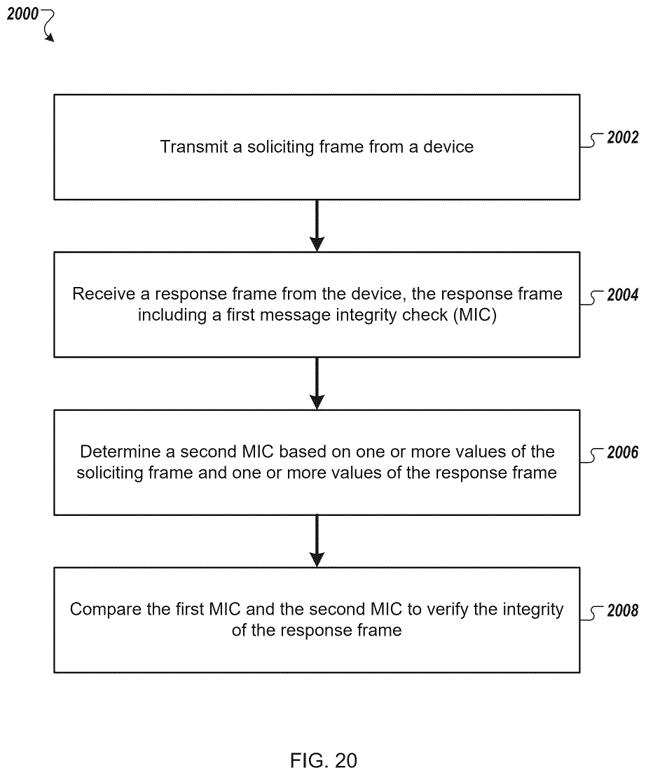

FIG. 20 illustrates a flowchart of an example method 2000, according to some implementations. For clarity of presentation, the description that follows generally describes method 2000 in the context of the other figures in this description. For example, method 2000 can be performed by device(s) 210 of FIG. 2. It will be understood that method 2000 can be performed, for example, by any suitable system, environment, software, hardware, or a combination of systems, environments, software, and hardware, as appropriate. In some implementations, various steps of method 2000 can be run in parallel, in combination, in loops, or in any order.

Operations of the method 2000 include transmitting a soliciting frame to a device (2002). The soliciting frame can include, for example, a control frame, a trigger frame, or a block acknowledgement request (BAR) frame, among others. A response frame including a first message integrity check (MIC) is received (2004). In some examples, the response frame includes a BA for the soliciting frame. A second MIC is determined based in part on one or more values of the soliciting frame and one or more values of the response frame (2006). The one or more values of the soliciting frame can include, for example, one or more values of one or more fields in a medium access control (MAC) header of the soliciting frame, such as the HDR PN and/or one or more static fields of the MAC header (e.g., a power management field, a more data field, an end of service period (EOSP) field, a high-throughput control field, and/or a reserved field).

The first MIC and the second MIC are compared to verify the integrity of the response frame (2008). In some examples, comparison of the first MIC and the second MIC also verifies receipt of the soliciting frame by the device. In some examples, the method 2000 includes accepting the response frame in response to determining that the first MIC matches the second MIC; or rejecting the response frame in response to determining that the first MIC does not match the second MIC.

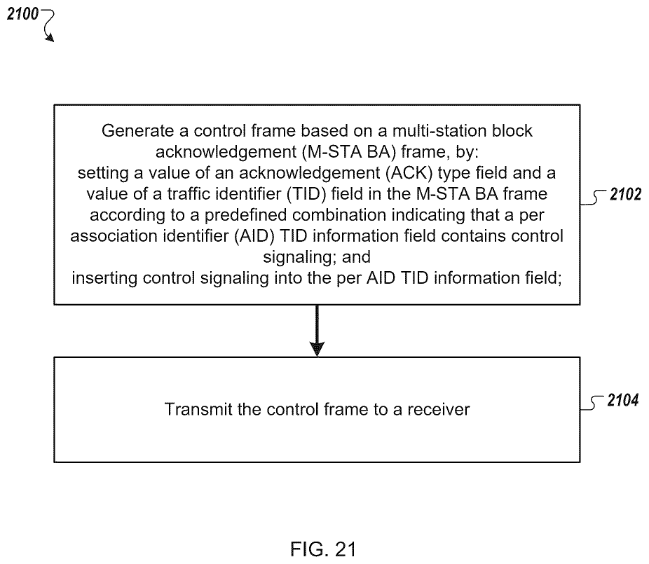

FIG. 21 illustrates a flowchart of an example method 2100, according to some implementations. For clarity of presentation, the description that follows generally describes method 2100 in the context of the other figures in this description. For example, method 2100 can be performed by device(s) 210 or access point 212 of FIG. 2. It will be understood that method 2100 can be performed, for example, by any suitable system, environment, software, hardware, or a combination of systems, environments, software, and hardware, as appropriate. In some implementations, various steps of method 2100 can be run in parallel, in combination, in loops, or in any order.

Operations of the method 2100 include generating (2102) a control frame based on a multi-station block acknowledgement (M-STA BA) frame, by: setting a value of an acknowledgement (ACK) type field and a value of a traffic identifier (TID) field in the M-STA BA frame according to a predefined combination indicating that a per association identifier (AID) TID information field contains control signaling, and inserting control signaling into the per AID TID information field. The control frame is then transmitted to a receiver (2104). In some examples, generating the control frame further includes setting a value of a frame control type field to control frame; and setting a value of a frame control subtype field to block ack frame. In some examples, generating the control frame includes setting a BA type field to a value of 12. In some examples, the predefined combination indicating that the per AID TID information field contains control signaling includes setting the value of the ACK type field to 1 and the value of the TID field to 12. In some examples, inserting the control signaling into the per AID TID information field includes inserting the control signaling into a BA bitmap.

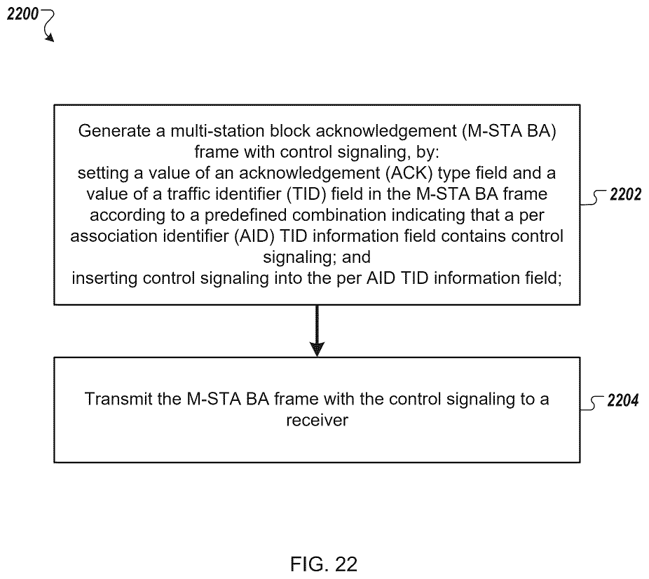

FIG. 22 illustrates a flowchart of an example method 2200, according to some implementations. For clarity of presentation, the description that follows generally describes method 2200 in the context of the other figures in this description. For example, method 2200 can be performed by device(s) 210 or access point 212 of FIG. 2. It will be understood that method 2200 can be performed, for example, by any suitable system, environment, software, hardware, or a combination of systems, environments, software, and hardware, as appropriate. In some implementations, various steps of method 2200 can be run in parallel, in combination, in loops, or in any order.

Operations of the method 2200 include generating (2202) a multi-station block acknowledgement (M-STA BA) frame with control signaling, by: setting a value of an acknowledgement (ACK) type field and a value of a traffic identifier (TID) field in the M-STA BA frame according to a predefined combination indicating that a per association identifier (AID) TID information field contains control signaling, and inserting control signaling into the per AID TID information field. The M-STA BA frame with the control signaling is transmitted to a receiver (2204). In some examples, generating the M-STA BA frame includes setting a value of a frame control type field to control frame; and setting a value of a frame control subtype field to block ack frame. In some examples, generating the M-STA BA frame includes setting a BA type field to a value of M-STA BA. In some examples, the predefined combination indicating that the per AID TID information field contains control signaling includes setting the value of the ACK type field to 1 and the value of the TID field to 12. In some examples, inserting the control signaling into the per AID TID information field includes inserting the control signaling into a BA bitmap. In some examples, generating the M-STA BA frame includes setting an AID11 field with an AID of the receiver.

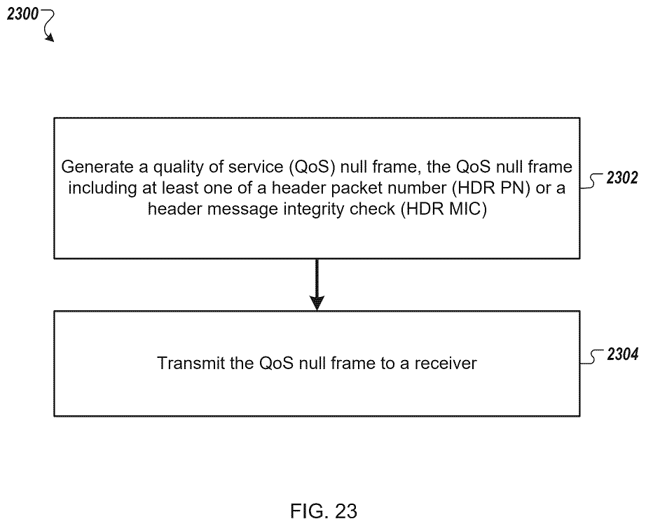

FIG. 23 illustrates a flowchart of an example method 2300, according to some implementations. For clarity of presentation, the description that follows generally describes method 2300 in the context of the other figures in this description. For example, method 2300 can be performed by device(s) 210 or access point 212 of FIG. 2. It will be understood that method 2300 can be performed, for example, by any suitable system, environment, software, hardware, or a combination of systems, environments, software, and hardware, as appropriate. In some implementations, various steps of method 2300 can be run in parallel, in combination, in loops, or in any order.

Operations of the method 2300 include generating a quality of service (QOS) null frame (2302). The QoS null frame includes at least one of a header packet number (HDR PN) or a header message integrity check (HDR MIC). In some examples, the QoS null frame further includes at least one of an indication whether the QoS null frame is integrity protected, or a key used for the HDR MIC calculation. The QoS null frame is then transmitted to a receiver (2304).

FIG. 24 illustrates a block diagram of an electronic device 2400, according to some implementations. The electronic device 2400 can be a cellular telephone, a smartwatch, an access point, a wireless speaker, an Internet-of-Things (IoT) device, among other examples. The electronic device 2400 includes hardware resources 2402 that include one or more processors (or processor cores) 2410, one or more memory/storage devices 2420, and one or more communication resources 2430, each of which can be communicatively coupled via a bus 2440.

The one or more processors 2410 include one or more devices configured to perform computational operations. For example, the one or more processors 2410 can include one or more microprocessors, application-specific integrated circuits (ASICs), microcontrollers, graphics processing units (GPUs), programmable-logic devices, and/or one or more digital signal processors (DSPs). The processors 2410 can include, for example, a processor 2412 and a processor 2414. The processor(s) 2410 can be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 2420 can include main memory, disk storage, or any suitable combination thereof. The memory/storage devices 2420 can include, but are not limited to, any type of volatile or nonvolatile memory such as dynamic random-access memory (DRAM), static random-access memory (SRAM), erasable programmable read-only memory (EPROM), electrically erasable programmable read-only memory (EEPROM), Flash memory, solid-state storage, etc. In some implementations, the memory/storage devices 2420 are coupled to one or more high-capacity mass-storage devices (not shown). In some examples, memory/storage devices 2420 can be coupled to a magnetic or optical drive, a solid-state drive, or another type of mass-storage device. In these examples, the memory/storage devices 2420 can be used by electronic device 2400 as fast-access storage for often-used data, while the mass-storage device is used to store less frequently used data.

The communication resources 2430 can include interconnection or network interface components or other suitable devices to communicate with one or more peripheral devices 2404 or one or more databases 2406 via a network 2408. For example, the communication resources 2430 can include wired communication components (e.g., for coupling via USB), cellular communication components, NFC components, Bluetooth® (or Bluetooth® Low Energy) components, Wi-Fi® components, and other communication components.

The communication resources 2430 include one or more devices configured to couple to and communicate on a wired and/or wireless network (i.e., to perform network operations), such as: control logic, one or more interface circuits and a set of antennas (or antenna elements) in an adaptive array that can be selectively turned on and/or off by control logic to create a variety of optional antenna patterns or “beam patterns.” Alternatively, instead of the set of antennas, in some examples, electronic device 2400 includes one or more nodes, e.g., a pad or a connector, which can be coupled to the set of antennas. Thus, electronic device 2400 might or might not include the set of antennas. For example, communication resources 2430 can include a Bluetooth™ networking system, a cellular networking system (e.g., a 3G/4G/5G/6G network such as UMTS, LTE, etc.), a universal serial bus (USB) networking system, a networking system based on the standards described in IEEE 802.11 (e.g., a Wi-Fi® networking system), an Ethernet networking system, and/or another networking system.

In some implementations, communication resources 2430 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

The communication resources 2430 include processors, controllers, radios/antennas, sockets/plugs, and/or other devices used for coupling to, communicating on, and handling data and events for each supported networking system. Note that mechanisms used for coupling to, communicating on, and handling data and events on the network for a network system are sometimes collectively referred to as a “network interface” for the network system.

Instructions 2450 can include software, a program, an application, an applet, an app, or other executable code for causing at least any of the processors 2410 to perform any one or more of the methodologies discussed herein. The instructions 2450 can reside, completely or partially, within at least one of the processors 2410 (e.g., within the processor's cache memory), the memory/storage devices 2420, or any suitable combination thereof. In some implementations, any portion of the instructions 2450 can be transferred to the hardware resources 2402 from any combination of the peripheral devices 2404 or the databases 2406. Accordingly, the memory of processors 2410, the memory/storage devices 2420, the peripheral devices 2404, and the databases 2406 are examples of computer-readable and machine-readable media.

While the preceding discussion used a Wi-Fi communication protocol as an illustrative example, in other implementations a wide variety of communication protocols and, more generally, wireless communication techniques can be used. Thus, the communication techniques can be used in a variety of network interfaces. Furthermore, while some of the operations in the preceding implementations were implemented in hardware or software, in general the operations in the preceding implementations can be implemented in a wide variety of configurations and architectures. Therefore, some or all of the operations in the preceding implementations can be performed in hardware, in software or a combination of both. For example, at least some of the operations in the communication techniques can be implemented using instructions 2450, operating system (such as a driver for an interface circuit in communication resources 2430) or in firmware in an interface circuit in communication resources 2430. Additionally or alternatively, at least some of the operations in the communication techniques can be implemented in a physical layer, such as hardware in an interface circuit in communication resources 2430. In some implementations, the communication techniques are implemented, at least in part, in a MAC layer and/or in a physical layer in an interface circuit in communication resources 2430.

While the preceding implementations illustrated the use of wireless signals in one or more bands of frequencies, in some implementations, electromagnetic signals in one or more different frequency bands are used to determine the range. For example, these signals can be communicated in one or more bands of frequencies, including: a microwave frequency band, a radar frequency band, 900 MHZ, 2.4 GHz, 5 GHZ, 6 GHz, 60 GHz, and/or a band of frequencies used by a Citizens Broadband Radio Service, by LTE, 5G, or any other communication system.

Although specific components are used to describe electronic device 2400, in some implementations, different components and/or subsystems can be present in electronic device 2400. For example, electronic device 2400 can include one or more additional processing subsystems, memory subsystems, networking subsystems, and/or display subsystems. Additionally, one or more of the subsystems might not be present in electronic device 2400. In some implementations, electronic device 2400 can include one or more additional subsystems that are not shown in FIG. 24. In some implementations, electronic device can include an analysis subsystem that performs at least some of the operations in the communication techniques. Although separate subsystems are shown in FIG. 24, in some implementations some or all of a given subsystem or component can be integrated into one or more of the other subsystems or component(s) in electronic device 2400.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method, comprising:
receiving a soliciting frame from a device;
generating a response frame comprising a message integrity check (MIC), wherein the MIC is determined based at least in part on one or more values of the soliciting frame; and
transmitting the response frame to the device.

2. The method of claim 1, wherein the one or more values of the soliciting frame comprise one or more values of one or more fields in a medium access control (MAC) header of the soliciting frame.

3. The method of claim 2, wherein the one or more fields in the MAC header of the soliciting frame comprise at least one of a power management field, a more data field, an end of service period (EOSP) field, a high-throughput control field, or a reserved field.

4. The method of claim 2, wherein the one or more fields in the MAC header of the soliciting frame comprise one or more static fields.

5. The method of claim 1, wherein the one or more values of the soliciting frame comprise a header packet number (HDR PN) of the soliciting frame.

6. The method of claim 1, wherein the soliciting frame comprises a control frame, a trigger frame, or a block acknowledgement request (BAR) frame.

7. The method of claim 1, wherein the MIC is determined based on the one or more values of the soliciting frame and one or more values of the response frame.

8. The method of claim 1, wherein the response frame comprises a block acknowledgement for the soliciting frame.

9. The method of claim 1, wherein the one or more values of the soliciting frame comprise a value of a duration field of the soliciting frame.

10. A method, comprising:
generating a control frame based on a multi-station block acknowledgement (M-STA BA) frame, by:
setting a value of an acknowledgement (ACK) type field and a value of a traffic identifier (TID) field in the M-STA BA frame according to a predefined combination indicating that a per association identifier (AID) TID information field contains control signaling; and
inserting control signaling into the per AID TID information field; and
transmitting the control frame to a receiver.

11. The method of claim 10, wherein generating the control frame further comprises:
setting a value of a frame control type field to control frame; and
setting a value of a frame control subtype field to block ack frame.

12. The method of claim 10, wherein generating the control frame further comprises setting a BA type field to a value of 12.

13. The method of claim 10, wherein the predefined combination indicating that the per AID TID information field contains control signaling comprises setting the value of the ACK type field to 1 and the value of the TID field to 12.

14. The method of claim 10, wherein inserting the control signaling into the per AID TID information field comprises inserting the control signaling into a BA bitmap.

15. A method, comprising:
generating a multi-station block acknowledgement (M-STA BA) frame with control signaling, by:
setting a value of an acknowledgement (ACK) type field and a value of a traffic identifier (TID) field in the M-STA BA frame according to a predefined combination indicating that a per association identifier (AID) TID information field contains control signaling; and
inserting control signaling into the per AID TID information field; and
transmitting the M-STA BA frame with the control signaling to a receiver.

16. The method of claim 15, wherein generating the M-STA BA frame further comprises:
setting a value of a frame control type field to control frame; and
setting a value of a frame control subtype field to block ack frame.

17. The method of claim 15, wherein generating the M-STA BA frame further comprises setting a BA type field to a value of M-STA BA.

18. The method of claim 15, wherein the predefined combination indicating that the per AID TID information field contains control signaling comprises setting the value of the ACK type field to 1 and the value of the TID field to 12.

19. The method of claim 15, wherein inserting the control signaling into the per AID TID information field comprises inserting the control signaling into a BA bitmap.

20. The method of any of claim 15, wherein generating the M-STA BA frame further comprises setting an AID11 field with an AID of the receiver.
